(19) United States
(12) Patent Application Publication
(10) Pub. No.: US 2003/0030315 A1
(43) Pub. Date: Feb. 13, 2003

(54) Adjusting device for backrests of vehicle seats, in particular motor vehicle seats

(76) Inventor: Phil Charles Shephard, Birmingham (GB)

Correspondence Address: LERNER AND GREENBERG, P.A., PATENT ATTORNEYS AND ATTORNEYS AT LAW, Post Office Box 2480, Hollywood, FL, 33022-2480, US

(21) Appl. No.: 10/227,913

(22) Filed: Aug. 26, 2002

Related U.S. Application Data
(63) Continuation of application No. PCT/EP01/02098, filed on Feb. 23, 2001.

(30) Foreign Application Priority Data
Feb. 25, 2000 (DE) 100 09 016.8
Apr. 15, 2000 (DE) 100 18 733.1

(51) Int. Cl. B60N 2/02

(52) U.S. Cl. 297/366

(57) ABSTRACT

An adjustment device for adjusting a backrest of a vehicle seat, in particular a motor vehicle seat, is provided. The adjustment device has a backrest arm which can be directly or indirectly coupled with a backrest. The backrest arm can pivot about a fixed pivot axis which is preferably embodied as a pivot pin. An engagement profile which interacts with a mating profile of a sliding locking element is preferably provided on the backrest arm. The sliding locking element can be adjusted relative to the backrest arm through the use of an actuating device, in such a way that the mating profile can be disengaged from the engagement profile for at least a partial release of a pivoting action of the backrest arm.

### CROSS-REFERENCE TO RELATED APPLICATION

This application is a continuation of copending International Application No. PCT/EP01/02098, filed Feb. 23, 2001, which designated the United States and was not published in English.

### BACKGROUND OF THE INVENTION

### FIELD OF THE INVENTION

The invention relates to an adjusting device for backrests of vehicle seats, in particular for backrests of motor vehicle seats.

Conventional adjusting devices for backrests of vehicle seats are generally constructed in such a manner that relatively large and heavy adapting plates are required in order to convert radial forces and torque forces into vertical securing forces. It is difficult to construct an adjusting device of this type, which has relatively large and heavy adapting plates, in a compact manner. Furthermore, there is the risk that the adapting plates press through the backrest when the seat is loaded with a normal load on the seat. This reduces the seat comfort for the seat user.

### SUMMARY OF THE INVENTION

It is accordingly an object of the invention to provide an adjusting device for adjusting a backrest of vehicle seats, in particular motor vehicle seats, which overcomes the above-mentioned disadvantages of the heretofore-known adjusting devices of this general type and which is of simple and compact construction and which provides a favorable flow of forces and/or distribution of forces applied thereto.

With the foregoing and other objects in view there is provided, in accordance with the invention, an adjusting device for adjusting a backrest, including:

a backrest arm configured to be coupled to the backrest, the backrest arm defining a positionally fixed pivot axis and being pivotable about the positionally fixed pivot axis, the backrest arm having an engagement profile formed thereon;

a sliding locking element having a mating profile interacting with the engagement profile of the backrest arm; and

an actuating device for adjusting the sliding locking element relative to the backrest arm, the actuating device at least partially disengaging the mating profile from the engagement profile for at least a partial release of a pivoting action of the backrest arm.

In other words, according to the invention, there is provided an adjusting device having a backrest arm which can be coupled indirectly or directly to a backrest and can be pivoted about a positionally fixed pivot axis preferably formed by a pivot pin, an engagement profile also being formed on the backrest arm, the engagement profile interacting with a mating profile of a sliding locking element. This sliding locking element can be adjusted relative to the backrest arm through the use of an actuating device, with the result that the mating profile can be at least partially disengaged from the engagement profile for the at least partial release of the pivoting action of the backrest arm.

As a separate component, a sliding locking element of this type can be adjusted relative to the backrest arm in a simple manner, even if the backrest arm is being subjected to an operating load, which is the case, for example, if a seat user is sitting on the vehicle seat or the backrest is preloaded in another manner. This enables the backrest to be adjusted all in all in a simple and force-saving manner.

This adjustment of the backrest can be designed for very high loads in a very compact construction with comfort taken into consideration.

The pivot axis, which is fixed in position and is preferably formed by a pivot pin, has the effect that the entire mechanism, if its actuation is to take place, for example, synchronously with other mechanisms, needs merely to be aligned with the same axis with minimal consideration of tolerances. The actuation of a plurality of such adjusting devices can then take place, for example from a distance, in a simple manner through the use of a cable pull or a narrow wire. Such a positionally fixed pivot pin as pivot axis therefore permits the interaction of similar mechanisms without them being directly connected, which results in varied freedom in terms of structure, in particular for realizing a compact construction.

In particular, such a construction of the adjusting device with a sliding locking element can also be of very compact design, i.e. of relatively small construction. As a result, the adjusting device can advantageously be arranged in the region of a backrest in such a manner that the risk of individual components pressing through the backrest is considerably reduced, which results, in turn, in a substantial increase in seat comfort.

In principle, the engagement profile and the mating profile can be of any configuration desired as long as it is ensured that, firstly, they can block pivoting of the backrest arm and, secondly, can release a pivoting action, it also being possible to configure the engagement profile and the mating profile in such a manner that also just a partial pivoting action of the backrest arm can be released depending on the state of engagement, for example in certain intermediate positions between two maximum adjustment positions of the sliding locking element.

Furthermore, an adjusting device of this type can be used universally, for example for backrests of reclining seats in motor vehicles, and in particular also in the case of divided seat-bench systems of a second or rear row with a seat belt integrated in the backrest for the vehicle occupant sitting in the center.

In a particularly preferred embodiment, the sliding locking element is of a plate-like configuration and has the mating profile on an end side assigned to the engagement profile, the sliding locking element in the assembled state lying approximately in the pivoting plane of the backrest arm, with the result that the two opposite side surfaces of the plate-like sliding locking element are orientated approximately transversely to the longitudinal direction of the pivot axis. A sliding locking element of this type can be produced simply and at reasonable cost, with high functional reliability. In addition, a particularly compact construction is thereby possible. In a preferred, specific refinement in this regard, the engagement profile is formed on a free end of the backrest arm, which end is at the bottom in a normal position of the backrest arm, the mating profile being formed on an upper end side of the plate-like sliding locking element. As a result, the sliding locking element can be adjusted approximately vertically, i.e. upward and downward in the normal position of the backrest arm, for the mating profile to engage with the engagement profile.

The sliding locking element is connected to at least one sliding element as part of the actuating device, the sliding element being guided displaceably and held in a guide slot of a securing element, which can be arranged in a fixed position, with the result that when the at least one sliding element is displaced in the guide slot, the sliding locking element can be adjusted relative to the backrest arm. In this case, the securing element, which can be arranged in a fixed position, is preferably configured as a securing plate which can be connected fixedly to the vehicle floor. With a construction of this type, the floor securing forces can advantageously be used in order to increase the locking capability of the adjusting device in situations with high loading, as is the case, for example in an impact, since the forces are passed here via the securing element directly into the region of the at least one sliding element, and therefore of the sliding locking element and of the backrest arm, which advantageously furthers the press-on force of the mating profile against the engagement profile. As a result, a favorable flow of force is therefore possible, the flow permitting, without loss of function and without reducing the intrinsic strength, the adjusting device to be of a smaller size overall, i.e., in particular, without the heavy adapting plates customarily used in the prior art. Furthermore, using such a sliding element, which is guided in a guide slot of a positionally fixed securing element, a compact and independent mechanism is provided in which the structural core parts are attached to one another.

A particularly compact and functionally reliable construction results if the respective sliding element connected to the sliding locking element is provided on both sides of the sliding locking element, as seen in the longitudinal direction of the pivot axis. In this case, each of these two sliding elements is guided displaceably and held in a guide slot of a securing element arranged in a fixed position on both sides of the sliding locking element. In addition, a construction of this type is also distinguished by particularly high strength, which is advantageous, in particular in situations with high loading, such as, for example, in the case of an impact. These securing elements are advantageously securing plates which can be produced particularly simply and therefore at reasonable cost. In principle, it is also possible for two or more sliding elements to be arranged on both sides of the sliding locking element.

All of the sliding elements are preferably connected to the sliding locking element through the use of at least one securing pin, wherein preferably two securing pins are used which penetrate the sliding elements which are provided and also the sliding locking element. Such a connecting possibility can likewise be produced simply and at reasonable cost and, in addition, ensures high functional reliability.

In principle, there are various possibilities for the configuration of the guide slot and the sliding element guided displaceably therein. In one specific and particularly preferred embodiment, the guide slot is configured to be larger than the sliding element, with the result that when the actuating device is actuated, the sliding element can be displaced in the guide slot in a constrained manner between a first displacement position and a second displacement position. In the first displacement position, the mating profile is in an engaged position with the engagement profile while, in the second displacement position, the mating profile is disengaged from the engagement profile of the backrest arm. In a particularly preferred embodiment, as has already been explained in greater detail above, if appropriate a pivoting action of the backrest arm, which action is reduced with respect to the maximum pivoting angle, may also be possible in intermediate positions depending on the geometry of the engagement profile and of the mating profile.

For a compact construction, a sliding element is preferably of plate-like and approximately rectangular design in the form of a sliding block, the plate-like sliding element and the securing element preferably having the same material thickness, with the result that in the assembled or fitted state of the adjusting device the plate-like sliding element is flush with at least those outer side wall regions of the securing element which directly surround the guide slot. The securing element is advantageously configured as a securing plate with approximately the same material thickness throughout, with the result that in the assembled state a particularly compact construction of the adjusting device is possible, the adjusting device being, in particular, eminently suitable for the narrow installation situations provided in the backrest region. Furthermore, also in this regard the production of a sliding element of this type is possible in a reasonably priced and simple manner.

At least one of the sliding elements is coupled to the actuating device, which acts as a release device, for adjusting the at least one sliding element, and therefore the sliding locking element, relative to the backrest arm. With two sliding elements arranged on opposite sides of the sliding locking element each one can be assigned an actuating device, it being possible for one of these two actuating devices then to serve as an equalizing device for ready and reliable guidance during the adjustment of the sliding elements and therefore of the sliding locking element relative to the backrest arm.

In a specific embodiment, the actuating device further includes a connecting plate, which is connected to the sliding element, and, in addition, a guide pin which protrudes from the connecting plate. This guide pin is guided in a guide slot of a pivot plate of the actuating device in such a manner that when the pivot plate is pivoted about a positionally fixed pivot-plate pivot axis, the constrained guidance in the guide slot enables the guide pin, and therefore also the connecting plate, to be adjusted relative to the securing element. As a result, in turn, the sliding element, which is connected to the connecting plate, is displaced in the sliding-element guide slot. The pivot plate can be coupled to an operating element, for example to a lever, a push-button or the like, which, for example, can be operated manually by the seat user. A construction of this type results in a particularly force-saving possibility of locking and unlocking the adjusting device even when a vehicle seat is subjected to a normal operating load.

An advantageous integration of functions and therefore a reduction in components results by the pivot-plate pivot axis being formed by a subregion or partial region of a pivot pin forming the backrest-arm pivot axis. In a preferred, specific embodiment, this subregion can be formed by one end of the pivot pin which is of reduced diameter in comparison with the pivot-pin central region.

The positionally fixed pivot pin extends through a recess, which is formed in the connecting plate and is preferably configured as an oblong recess which can be produced simply and at reasonable cost, with the result that the connecting plate can also be moved, preferably can at least be raised and lowered, relative to the positionally fixed pivot pin.

In a particularly preferred embodiment, provision is made for at least one cylindrical pin element to be arranged, as seen in the longitudinal direction of the pivot axis, in each case on both sides of left and right end sides bounding the side surfaces of the plate-like sliding locking element, the pin element extending in the longitudinal direction of the pivot axis and, in the assembled state of the adjusting device, being held in each case between the two securing elements. Using pin elements of this type, the strength of the adjusting device can advantageously also be substantially increased, in particular in the case of an impact in which high loads occur, with the result that all in all good conditions for the flow or distribution of forces are provided without requiring a great outlay on components. This is also the case, in particular, if, as in a particularly advantageous embodiment in this regard, a preferably identically sized gap spacing is formed in each case between the cylindrical pin elements and the left and right end side of the sliding locking element. This advantageously achieves the effect that, for example in the case of an impact in which the sliding elements are displaced together with the sliding locking element laterally, i.e. in the longitudinal direction of the pivot axis, the respective gap spacing is closed after a certain displacement path, with the result that the respective load direction profile of the cylindrical pin element prevents further deformation of the sliding elements. As a result, the adjusting device advantageously obtains, in a simple manner, high strength, in particular in the case of an impact in which very high loads occur.

In a specific embodiment, the cylindrical pin elements have a central cylinder region adjoined in each case at both ends, as seen in the longitudinal direction of the pivot axis, by cylindrical bearing pins of smaller diameter through the use of which the cylindrical pin elements are mounted on the securing elements. Also advantageously, the cylindrical pin elements have, as seen in the longitudinal direction of the pivot axis, approximately the same width as the sliding locking element, with the result that in the assembled state of the adjusting device the securing elements and/or the sliding elements bear against the end surfaces of the sliding locking element or are arranged directly adjacent thereto. This also contributes in turn to the construction being altogether very compact.

The positionally fixed pivot axis of the backrest arm is preferably formed by a pivot pin which is arranged in a non-rotatable manner, in which case, in a preferred design, the pivot pin can preferably extend, from the backrest arm, on both sides of the backrest arm through a securing element and optionally through a connecting plate and/or optionally through a pivot plate.

In a particularly preferred embodiment, the engagement profile and the mating profile are formed in each case by a toothed profile which makes possible a lateral displacement of the sliding locking element relative to the backrest arm in the longitudinal direction of the pivot axis as a function of a certain action of force even when the engagement profile is in engagement with the mating profile. This is advantageous, in particular in conjunction with the cylindrical pin elements, in the event of an impact, since then in that case the lateral displacement of the sliding locking element, and therefore of the sliding elements, is ensured in a simple manner.

The backrest arm is basically of long stretched-out design and, in a normal position, is orientated approximately vertically, the pivot axis lying at a distance from the free ends of the backrest arm. The distance to a free end of the backrest arm, which end is at the bottom in the normal position, is smaller, preferably substantially smaller, than to that free end of the backrest arm which is at the top in the normal position. As a result, the locking parts of the adjusting device, namely the sliding locking element and the sliding elements interacting therewith, can be arranged relatively low down on the adjusting device which means that parts can advantageously be prevented from pressing through the backrest in all adjustment positions.

As a sliding locking device, two sliding elements are preferably guided in a guide slot thereby ensuring a tilt-free function both for upward adjustment and for downward adjustment. In addition, in the event of a crash the energy introduced through relatively large bearing surfaces can be much better dissipated into the floor securing plates and into the floor.

The locking element is preferably adjusted by two actuating devices. In this manner, in the event of a crash the locking element can be held much longer in the locked state. This favorable effect is also supported by the guide slots in the pivot plates, which guide slots are configured to self-lock in the locking state.

The double use of the pivot axis of the pivot pin makes substantial contributions to the compact construction and actuation according to the invention. Furthermore, the actuating devices can be activated in a simple manner by the common pivot axis and the manual triggering device can be accommodated flexibly in the backrest.

According to another feature of the invention, the cylindrical pin elements serve as a secondary crash support in the event of a crash. With a yielding guide slot in the floor securing plates, the sliding locking element can additionally be supported on the cylindrical pin elements and can dissipate force into the floor securing plates. If the cylindrical pin elements are preferably configured as eccentrics, the latter can be used as an adjustable tolerance-compensation.

According to another feature of the invention, an adjusting device is provided which is also functional in a kinematic reverse manner—i.e. the backrest arm as a fixed base and moveable parts in the backrest.

With the objects of the invention in view there is also provided, in combination with a backrest, an adjusting device for adjusting the backrest, including:

a backrest arm coupled to the backrest, the backrest arm defining a positionally fixed pivot axis and being pivotable about the positionally fixed pivot axis, the backrest arm having an engagement profile formed thereon;

a sliding locking element having a mating profile interacting with the engagement profile of the backrest arm; and

an actuating device for adjusting the sliding locking element relative to the backrest arm, the actuating device at least partially disengaging the mating profile from the engagement profile for at least a partial release of a pivoting action of the backrest arm.

According to another feature of the invention, the backrest has an occupant safety zone configured as a contact avoiding zone; and the adjusting device, when in an assembled state, is disposed in a region of the backrest outside the occupant safety zone.

The adjusting device according to the invention permits a very torsion-proof design. This is of outstanding significance because, in the event of a crash, a strong torsion component is introduced into the adjusting device via the backrest arm, with the result that the engagement profiles attempt to rotate relative to one another. The specific design of the floor securing plates ensures that the optimum locking state for the introduction of force is maintained. Further measures as a supplement or alternative may be:

support of the floor securing plates by the actuating devices attached on both sides,

support of the floor securing plates by the cylindrical pin elements,

deformation-proof design of the base part.

Other features which are considered as characteristic for the invention are set forth in the appended claims.

Although the invention is illustrated and described herein as embodied in an adjusting device for backrests of vehicle seats, in particular motor vehicle seats, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a diagrammatic, perspective and exploded view of an adjusting device according to the invention with a sliding locking element disengaged from a backrest arm;

FIG. 2 is a diagrammatic, perspective and exploded view of an adjusting device according to the invention with a sliding locking element in engagement with the backrest arm;

FIG. 3 is a diagrammatic illustration of the sliding locking element with cylindrical pin elements which are disposed on both sides of the sliding locking element and which are spaced by a gap from the sliding locking element according to the invention; and

FIG. 4 is a diagrammatic perspective view of an exemplary installation situation for a rear seat system of a motor vehicle according to the invention.

### DESCRIPTION OF THE PREFERRED EMBODIMENTS

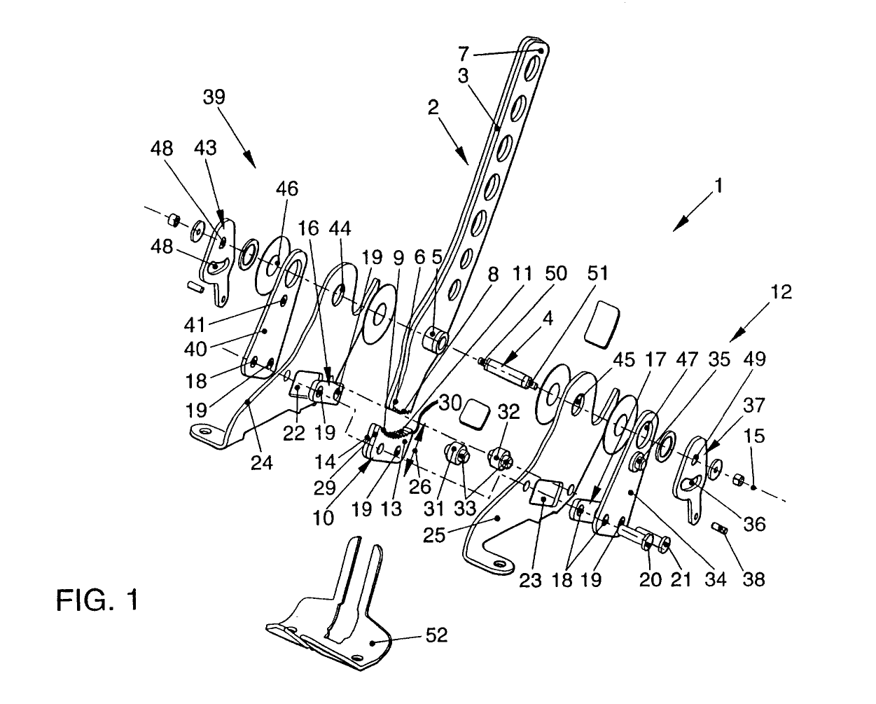

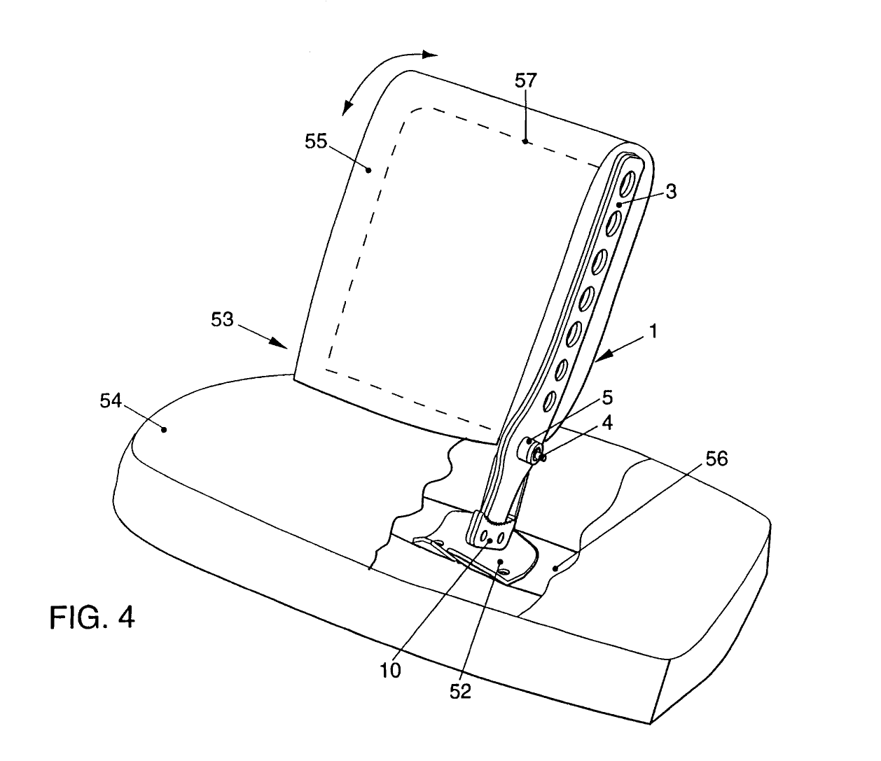

Referring now to the figures of the drawings in detail and first, particularly, to FIG. 1 thereof, there is shown an adjusting device 1 for backrests of vehicle seats, in particular motor vehicle seats. This adjusting device 1 includes a backrest arm 3 which is illustrated in a normal position 2 in FIG. 1 and can be coupled indirectly or directly to a backrest 55 (sketched in FIG. 4) of a rear seat system 53. The rear seat system 53 here has a ⅓-⅔ division in the backrest region, for which a framework 57 which is known per se is provided here. This rear seat system also includes a seat bench 54 which rests on a body panel 56. At the same time, a base part 52 is secured on the latter, through the use of a connecting technique, in particular a screw connection, for the purpose of mounting the backrest frame 3.

This backrest arm 3 can be pivoted about a pivot pin 4 which forms a positionally fixed pivot axis and is held in a corresponding receiving eye 5 of the backrest arm 3.

The backrest arm 3 is of long stretched-out design here, the pivot pin 4 being arranged at a distance from the free ends of the backrest arm 3, and the distance of the pivot pin 4 to a lower, free end 6 of the backrest arm 3 being substantially smaller than to the upper, free end 7 of the backrest arm.

As can further be gathered from FIG. 1, a toothed profile is formed as the engagement profile 8 on the lower, free end 6 of the backrest arm 3. This engagement profile 8 is assigned a toothed profile as mating profile 11, the toothed profile being formed on an upper end side 9 of a plate-like sliding locking element 10. The plate-like sliding locking element 10 lies approximately in the pivoting plane of the backrest arm 3, with the result that the two opposite side surfaces 13, 14 of the plate-like sliding locking element 10 are orientated approximately transversely to the longitudinal direction 15 of the pivot axis, which is defined by the pivot pin 4.

As is further apparent from FIG. 1, a respective sliding element 16, 17 configured as a sliding block is provided on both sides of the sliding locking element 10, as seen in the longitudinal direction 15 of the pivot axis. The sliding elements are part of an actuating device 12 and 39, respectively, actuable in the manner of a release device for adjusting the sliding elements 16, 17, and therefore the sliding locking element 10, relative to the backrest arm 3.

Like the sliding locking element 10, the sliding elements 16, 17 have two passage holes 18, 19 which are aligned with each other in the fitted state of the adjusting device 1. A respective securing pin 20, 21 is plugged through these passage holes 18, 19 in order to fix the sliding elements 16, 17 together with the sliding locking element 10 in a bearing connection against the side surfaces 13, 14.

As is further apparent from the illustration of FIG. 1, the sliding elements 16, 17 are of plate-like and approximately rectangular design and are guided displaceably and held in a guide slot 22, 23 of a respective floor securing plate 24, 25 arranged on both sides of the sliding locking element 10.

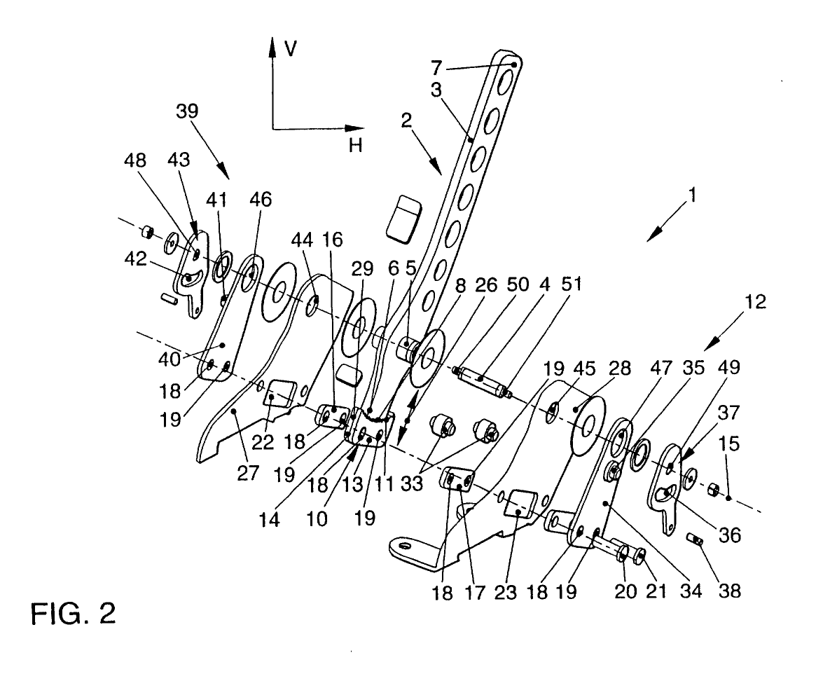

The guide slots 22, 23 are preferably configured here such that they are square and larger than the sliding elements 16, 17 held and guided displaceably therein, the sliding elements 16, 17 having approximately the same width as the guide slots 22, 23, but having a lower height than the guide slots 22, 23, with the result that the sliding elements 16, 17 can merely be moved in the vertical direction, i.e. in the direction of the longitudinal extent of the backrest arm 3 in the normal position 2 in order to adjust the sliding locking element 10 in accordance with the double arrow 26 in FIG. 1. The vertical direction V and the horizontal direction H are illustrated in FIG. 2

In FIG. 2, which shows a basically identical construction to the adjusting device 1 of FIG. 1, the sliding locking element 10 is in engagement, through the use of its mating profile 11, with the engagement profile 8 on the lower, free end 6 of the backrest arm 3 and therefore prevents the backrest arm 3 from pivoting about the pivot pin 4.

The floor securing plates 24, 25 are secured in a fixed position on the vehicle floor so as to permit the relative displacement of the sliding elements 16, 17 in the guide slot 22, 23, and therefore of the sliding locking element 10, relative to the floor securing plate 24, 25.

In the illustration of FIG. 2, identical parts are denoted by identical reference numbers, use having been made here of different floor securing plates 27, 28 in contrast to the embodiment according to FIG. 1.

As is further apparent from the schematic illustrations of FIGS. 1 and 2, the plate-like sliding elements 16, 17 and the floor securing plates 24, 25 have approximately the same material thickness.

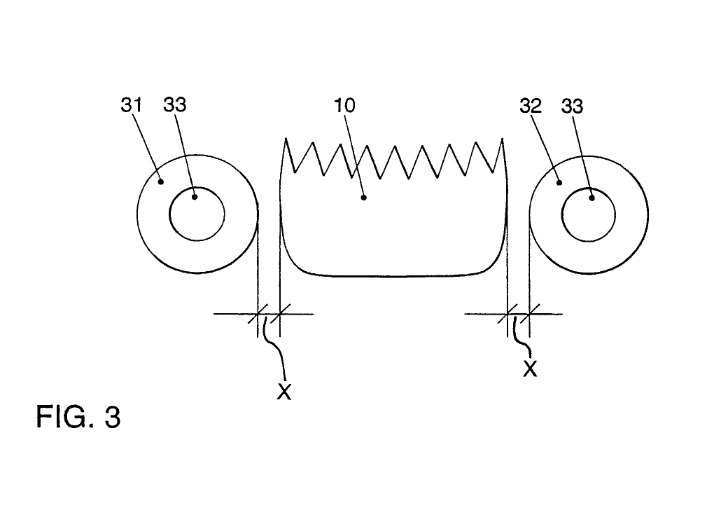

As is also apparent from FIG. 3, in particular, a respective cylindrical pin element 31, 32 is provided, as seen in the longitudinal direction 15 of the pivot axis, in each case on both sides of left and right end sides 29, 30 bounding the side surfaces 13, 14 of the plate-like sliding locking element 10, the pin element having a central cylinder region adjoined in each case, as seen in the longitudinal direction 15 of the pivot axis, at both ends by cylindrical bearing pins 33 of smaller diameter through the use of which the cylindrical pin elements 31, 32 can be mounted on the floor securing plates 24, 25.

In the assembled state, the cylindrical pin elements 31, 32 have, as seen in the longitudinal direction 15 of the pivot axis, approximately the same width as the sliding locking element 10, as a result of which it is ensured that in the assembled state of the adjusting device 1 the sliding elements 16, 17 bear against the side surfaces 13, 14 of the sliding locking element 10 and, at the same time, the sliding elements 16, 17 are also guided and held in the guide slots 22, 23 of the floor securing plates 24, 25 which, if appropriate, likewise bear at the edge against the sliding locking element.

As is apparent from FIG. 3, an identically sized gap spacing X is formed in each case between the cylindrical pin elements 31, 32 and the left and right end side 29, 30 of the sliding locking element 10.

The actuating device 12 furthermore includes a connecting plate 34 which likewise has passage holes 18, 19 and is connected fixedly to the sliding element 17 via the securing pins 20, 21. The connecting plate 34 furthermore has at an upper end a guide pin 35 which protrudes from the connecting plate 34 and, in the assembled state of the adjusting device 1, is guided in a guide slot 36 of a pivot plate 37 as a further component of the actuating device 12. When the pivot plate 37 is pivoted, the guide pin 35 is carried along in a constrained manner in the guide slot 36 and the connecting plate 34 is thus raised upward or lowered downward relative to the positionally fixed floor securing plate 25, as a result of which the sliding element 17, which is connected to the connecting plate 34, can be displaced in the sliding-element guide slot 23 in order to adjust the sliding locking element 10 relative to the backrest arm 3. The pivot plate 37 can be pivoted, for example, via a crank pin 38 (only illustrated schematically here).

In the engagement position shown in FIG. 2, pivoting of the backrest arm 3 is blocked. In contrast, in a lowered position, in which engagement profile 8 and mating profile 11 are disengaged, the pivoting of the backrest arm 3 is released.

The actuating device 39 is essentially of identical construction as the actuating device 12. The sliding element 16 is also connected here via the two securing pins 20, 21 to a connecting plate 40 which, in turn, is coupled in the manner just described to a guide slot 42 of a pivot plate 43 via a guide pin 41. However, in contrast to the actuating device 12, the actuating device 39 is used here merely as an equalizing device.

In addition, it can further be gathered from FIGS. 1 and 2 that from the backrest arm 3 the pivot pin 4 extends on both sides of the backrest arm 3 through corresponding recesses 44, 45 in the floor securing plates 24, 25 and oblong recesses 46, 47 in the connecting plates 34, 40 and through recesses 48, 49 in the pivot plates 37, 43. Shims may be provided between the individual components. The pivot pin 4 has a thicker central pivot-pin region and extends with a cylindrical bearing pin of smaller diameter formed at both ends through the recesses 48, 49 of the pivot plates 37, 43, with the result that these cylindrical bearing pins 50, 51 preferably form the pivot axis for the pivot plates 37, 43. Nuts may also be screwed onto the ends of the cylindrical bearing pins 50, 51.

The oblong recesses 46, 47 are larger than the pivot pin 4 so that the connecting plates 34, 40 can be raised and lowered relative to the pivot pin 4.

Such a construction of the adjusting device 1 enables the sliding locking element 10 to be adjusted, by actuation of the actuating device 12, in a simple force-saving manner and irrespective of a seat loading, between a first displacement position, in which the mating profile 11 is in an engaged position with the engagement profile 8, and a second displacement position, in which the mating profile 11 is disengaged from the engagement profile 8. It is also possible here, if appropriate, depending on the geometry of the engagement profile 8 and of the mating profile 11, for the backrest arm 3, and therefore the backrest, to be pivoted in defined pivoting angle ranges which are reduced in comparison with the maximum pivoting angle.

An adjusting device 1 of this type can be produced in a simple and reasonably priced manner from steel plate, pressed parts and lathe-tooled or forged spindles and pins, since special or expensive manufacturing processes are not required for this.

The use of the adjusting device is not restricted to the rear seat system shown in FIG. 4. The backrest 5 may extend as a single piece over the entire vehicle width or may be divided into halves of identical size. The adjusting device according to the invention can be installed both in the region of the center of the vehicle and adjacent to the side walls in a wide spectrum of vehicles (passenger vehicles, minibuses and coaches).

I claim:

1. An adjusting device for adjusting a backrest, comprising:
a backrest arm configured to be coupled to the backrest, said backrest arm defining a positionally fixed pivot axis and being pivotable about the positionally fixed pivot axis, said backrest arm having an engagement profile formed thereon;
a sliding locking element having a mating profile interacting with said engagement profile of said backrest arm; and
an actuating device for adjusting said sliding locking element relative to said backrest arm, said actuating device at least partially disengaging said mating profile from said engagement profile for at least a partial release of a pivoting action of said backrest arm.

2. The adjusting device according to claim 1, wherein:
said sliding locking element is a plate element having an end side assigned to said engagement profile of said backrest arm;
said mating profile of said sliding locking element is provided on said end side of said sliding locking element;
said backrest arm defines a pivoting plane, said sliding locking element, when in an assembled state, lies substantially in the pivoting plane of said backrest arm; and
said sliding locking element has two opposite side surfaces, said two opposite side surfaces of said sliding locking element extend substantially transversely to the pivot axis of said backrest arm.

3. The adjusting device according to claim 2, wherein:
said backrest arm has a lower free end in a normal position, said engagement profile is formed on said lower free end of said backrest arm; and
said sliding locking element has an upper end side, said mating profile is formed on said upper end side of said sliding locking element such that said sliding locking element is substantially vertically adjustable for engaging said mating profile and said engagement profile with one another.

4. The adjusting device according to claim 1, wherein:
said actuating device includes at least one sliding element;
a fixedly disposed securing element has a guide slot formed therein; and
said sliding locking element is connected to said at least one sliding element, said at least one sliding element is guided to be displaceable and held in said guide slot of said securing element such that when said at least one sliding element is displaced in said guide slot, said sliding locking element is adjustable relative to said backrest arm.

5. The adjusting device according to claim 4, wherein:
said sliding locking element has two sides extending substantially transverse to the fixed pivot axis of said backrest arm;
said at least one sliding element is configured as two sliding elements such that a respective one of said two sliding elements is provided on a respective one of said two sides of said sliding locking element, said two sliding elements are connected to said sliding locking element;
a further fixedly disposed securing element has a guide slot formed therein, said securing element and said further securing element are respectively disposed on said two sides of said sliding locking element; and
each of said two sliding elements is guided to be displaceable and held in said guide slot of a respective one of said securing element and said further securing element.

6. The adjusting device according to claim 5, including at least one securing pin penetrating at least said sliding elements, said at least one securing pin connecting said sliding elements to said sliding locking element.

7. The adjusting device according to claim 4, wherein said guide slot is dimensioned to be larger than said at least one sliding element such that when said actuating device is actuated, said at least one sliding element is displaceable in said guide slot in a constrained manner between a first displacement position with said mating profile in an engaged position with said engagement profile, and a second displacement position with said mating profile disengaged from said engagement profile of said backrest arm.

8. The adjusting device according to claim 7, wherein:
said at least one sliding element is at least one plate-shaped sliding element; and
said at least one sliding element and said fixedly disposed securing element have substantially identical material thicknesses such that when said adjusting device is in an assembled state, said at least one sliding element is substantially flush at least with outer side wall regions of said securing element surrounding said guide slot.

9. The adjusting device according to claim 5, wherein at least one of said two sliding elements is coupled to said actuating device as a release device for adjusting said at least one of said sliding elements and consequently adjusting said sliding locking element relative to said backrest arm.

10. The adjusting device according to claim 9, wherein a first one of said two sliding elements is assigned to said actuating device, a second one of said two sliding elements is assigned to a further actuating device serving as an equalizing device.

11. The adjusting device according to claims 4, wherein:
said actuating device includes a connecting plate connected to said at least one sliding element;
a guide pin protrudes from said connecting plate;
said actuating device further includes a pivot plate having a guide slot formed therein, said pivot plate defines a positionally fixed pivot-plate pivot axis; and
said guide pin is guided in said guide slot of said pivot plate such that when said pivot plate is pivoted about the positionally fixed pivot-plate pivot axis, said guide pin is guided in a constrained manner, and consequently said connecting plate is adjusted relative to said securing element, such that said at least one sliding element is displaced in said guide slot of said securing element.

12. The adjusting device according to claim 11, including a pivot pin having a subregion, said pivot pin embodying said pivot axis of said backrest arm, said subregion of said pivot pin embodying said pivot-plate pivot axis.

13. The adjusting device according to claim 12, wherein said pivot pin has a center region of a relatively larger diameter and end regions of relatively smaller diameters as said subregion such that said end regions of said pivot pin form the pivot-plate pivot axis.

14. The adjusting device according to claim 13, wherein:
said connecting plate has a recess formed therein, said recess is larger than said pivot pin; and
said pivot pin is positionally fixed and extends through said recess such that said connecting plate is movable relative to said positionally fixed pivot pin.

15. The adjusting device according to claim 13, wherein:
said connecting plate has an oblong recess formed therein, said oblong recess is larger than said pivot pin; and
said pivot pin is positionally fixed and extends through said oblong recess such that said connecting plate can at least be raised and lowered relative to said positionally fixed pivot pin.

16. The adjusting device according to claim 5, wherein:
said sliding locking element has a left end side and a right end side bounding two opposite side surfaces of said sliding locking element, said two opposite side surfaces extend substantially transversely to said pivot axis of said backrest arm;
pin elements are disposed such that at least one of said pin elements is in each case provided at said left end side and at said right end side, when viewed along the pivot axis of said backrest arm; and
said pin elements extend substantially parallel to the pivot axis of said backrest arm and, when in an assembled state, are held between said securing element and said further securing element.

17. The adjusting device according to claim 16, wherein said pin elements are cylindrical pin elements.

18. The adjusting device according to claim 17, wherein said pin elements are spaced by respective spacing distances from said left end side and from said right end side of said sliding locking element.

19. The adjusting device according to claim 17, wherein said pin elements are spaced by substantially identical respective spacing distances from said left end side and from said right end side of said sliding locking element.

20. The adjusting device according to claim 17, wherein said cylindrical pin elements have in each case a central cylinder region of a relatively larger diameter adjoined in each case at both ends thereof, when viewed along the pivot axis of said backrest arm, by cylindrical bearing pins of a relatively smaller diameter for mounting said cylindrical pin elements to said securing element and said further securing element.

21. The adjusting device according to claim 17, wherein said cylindrical pin elements, when in an assembled state and when measured in a direction of the pivot axis of said backrest arm, have a width substantially identical to a width of said sliding locking element such that, in an assembled state, at least one of said securing elements and said sliding elements bear against said side surfaces of said sliding locking element.

22. The adjusting device according to claim 1, wherein the positionally fixed pivot axis of said backrest arm is embodied as a pivot pin.

23. The adjusting device according to claim 22, wherein said pivot pin is a non-rotatably mounted pin.

24. The adjusting device according to claim 23, wherein said pivot pin extends from said backrest arm and extends through at least one element selected from the group consisting a securing element, a connecting plate and a pivot plate.

25. The adjusting device according to claim 3, wherein said engagement profile and said mating profile are in each case embodied as a toothed profile allowing a lateral displacement of said sliding locking element relative to said backrest arm in a direction of the pivot axis of said backrest arm in dependence of a force application even when said engagement profile is in engagement with said mating profile.

26. The adjusting device according to claim 1, wherein:
said backrest arm is an elongated arm extending substantially vertically when in a normal position;
the pivot axis of said backrest arm is spaced by a first distance from an upper free end of said backrest arm and by a second distance from a lower free end of said backrest arm when in the normal position; and
said first distance is larger than said second distance.

27. The adjusting device according to claim 4, wherein said securing element is a floor securing plate.

28. The adjusting device according to claim 4, wherein said fixedly disposed securing element is configured to be fixedly connected to a vehicle floor.

29. The adjusting device according to claim 5, including two securing pins penetrating at least said sliding elements, said two securing pin connecting said sliding elements to said sliding locking element.

30. The adjusting device according to claim 4, wherein said at least one sliding element is a substantially rectangular plate.

31. The adjusting device according to claim 7, wherein said at least one sliding element is movable to intermediate positions depending on a geometry of said engagement profile and of said mating profile for pivoting said backrest arm in given pivoting angle ranges wherein the given pivoting angle ranges are smaller than a maximum pivoting angle range.

32. In combination with a backrest, an adjusting device for adjusting the backrest, comprising:
a backrest arm coupled to the backrest, said backrest arm defining a positionally fixed pivot axis and being pivotable about the positionally fixed pivot axis, said backrest arm having an engagement profile formed thereon;
a sliding locking element having a mating profile interacting with said engagement profile of said backrest arm; and
an actuating device for adjusting said sliding locking element relative to said backrest arm, said actuating device at least partially disengaging said mating profile from said engagement profile for at least a partial release of a pivoting action of said backrest arm.

33. The adjusting device according to claim 32, wherein:
the backrest has an occupant safety zone configured as a contact avoiding zone; and
the adjusting device, when in an assembled state, is disposed in a region of the backrest outside the occupant safety zone.

34. The adjusting device according to claim 32, wherein the backrest is a vehicle seat backrest.

35. The adjusting device according to claim 32, wherein said backrest arm is indirectly coupled to the backrest

36. The adjusting device according to claim 32, wherein said backrest arm is directly connected to the backrest.
